(19) United States
(12) Patent Application Publication
(10) Pub. No.: US 2004/0184466 A1
(43) Pub. Date: Sep. 23, 2004

(54) MOBILE SERVER FOR INTERNETWORKING WPAN, WLAN, AND WWAN

(76) Inventors: Ju-Nan Chang, Taipei Hsien (TW); Meng-Hua Kao, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,124

(22) Filed: Mar. 18, 2003

(51) Int. Cl. H04L 12/28

(52) U.S. Cl. 370/401

(57) ABSTRACT

A mobile server for internetworking WPAN, WLAN, and WLAN used as an access point in mobile wireless communication applications. The mobile server includes a central network processor, a plurality of detachable WPAN, WLAN and WLAN adapters, and a storage device. The central network processor includes a flow controller and a bridge for dealing with data flow, detecting direction of the data flow, and transforming data types. The storage device is electrically connected to the central network processor for storing multimedia data and system codes.

### BACKGROUND OF INVENTION

1. Field of the Invention

The invention relates to a mobile server, and more particularly, to a mobile server installed with a storage device for providing services and for internetworking a WPAN (Wireless Personal Area Network), a WWAN (Wireless Wide Area Network), and a WLAN (Wireless Local Area Network).

2. Description of the Prior Art

Nowadays, WAN (Wireless Area Network) technology includes various kinds of topics, such as wireless voice and Internet connections over a long distance, and optical infrared and wireless frequency techniques for wireless connections over a short distance. The wireless apparatuses include a notebook, a desktop, a mobile computer, a personal digital assistant (PDA), a mobile phone, a tablet PC, a pager, and so on. People in motion can use their mobile phones to send or receive emails, passengers can use the internet through mobile computers wirelessly connected to access points in air ports, stations, and other public spaces, and users at home can deal with and transmit data synchronously with desktop apparatuses.

A universal network architecture of data transmission has to been established so that various kinds of electric instruments manufactured by different factories can follow the same standard to connect to the same network. Therefore the OSI (Open System Interconnection) is established as the standard of the network architecture. Under the architecture, the seven-layer model has been framed and the physical layer, one of the seven layers, is terminal to users and transforms the signals of hardware into the signals that computers can receive. There is no standard protocol of the physical layer. The second layer from the bottom is the data link layer and data packets are transmitted correctly on the network in the data link layer. The seven-layer model also includes the network layer, the transport layer, and so on.

The wireless network can be divided into several categories according to the distance of the data transmission, which includes WWAN (Wireless Wide Area Network), WMAN (Wireless Metropolitan Area Network), WLAN (Wireless Local Area Network), and WPAN (Wireless Personal Area Network). The present invention relates to the WWAN, the WLAN, and WPAN closely. The WLAN technology allows users to connect to networks wirelessly through multiple antennas and satellite systems of service providers in wide areas. The WLAN technology allows users to connect to networks wirelessly through access points in public spaces or buildings. The IEEE 802.11 specification allows transmission rate of one to two million bites per second (Mbps) in 1997. Additional details of data transmission format and transmission rate are established in the 802.11/a/b/g specification by IEEE. The WPAN technique allows users to establish personal wireless transmitting spaces with a longest diameter of 10 meters. Nowadays, the two major WPAN techniques are respectively “Bluetooth” and infrared transmission. “Bluetooth” utilizes EM waves, which are hardly blocked by any obstacle, to transmit data while the infrared transmission can achieve high-speed transmission within a certain distance such as one meter.

Nowadays, the wireless communication technology is not capable of supporting the data transmission of real-time multimedia economically and efficiently. The main obstacles are lack of communication bandwidth, poor communication quality, and bad integration of various kinds of wireless networks. Up to now, the wireless application is imperative for information users, so how to integrate the WWAN, the WLAN, and the WPAN for the communication industry and the academic field is an important topic. In U.S. Pat. Nos. 6,314,163 and 6,049,593, Acampora et al. pointed out a multi-hop concept of the WWAN and a basic operating method for improving the receiving signal quality. Hung-Yun, et al. in GNAN Research Group published the method of internetworking the WLAN and the WWAN by integrating the one-hop WLAN and multi-hop WWAN into a new communication architecture to simulate the integrating effect.

The trend of communication development is integrating different communication specifications. The above-mentioned prior art is complex due to the need to reframe a new network architecture, and the solution of the WPAN, the WLAN, and WWAN integration can not be achieved by an add-on apparatus. Moreover, the demands for multimedia information such as mp3 songs, real-time online movies, and so on are significantly increasing. Therefore, all the commercialized communication devices are challenged to provide better multimedia services for clients. The future will emphasize providing various multimedia services and integrating the WPAN, the WLAN, and the WWAN under the present architecture instead of building or reframing a new network architecture.

### SUMMARY OF INVENTION

It is therefore a primary objective of the claimed invention to provide a mobile server installed with at least a storage device used as an access point in mobile wireless communication applications for internetworking a WWAN, a WLAN, and a WPAN to solve the above-mentioned problem of the prior art.

According to the claimed invention, a mobile server is used as an access point in a wireless communication system for internetworking a WPAN, a WLAN, and a WWAN, the mobile server comprising: a central network processor comprising: a flow controller for dealing with data flow; and a bridge for transforming data types; at least one WPAN adapter detachably connected to the mobile server and electrically connected to the central network processor for transmitting, receiving, and processing data of a first data type; at least one WLAN adapter detachably connected to the mobile server and electrically connected to the central network processor for transmitting, receiving, and processing data of a second data type; at least one WWAN adapter detachably connected to the mobile server and electrically connected to the central network processor for transmitting, receiving, and processing data of a third data type; and at least one storage device electrically connected to the central network processor for storing data and programs.

According to the claimed invention, a mobile server is used as an access point in a wireless communication system for internetworking a WPAN, a WLAN, and a WWAN, the mobile server comprising: a physical layer circuit comprising: at least one WPAN adapter detachably connected to the mobile server and electrically connected to the central network processor for transmitting and receiving data of a first data type; at least one WLAN adapter detachably connected to the mobile server and electrically connected to the central network processor for transmitting and receiving data of a second data type; and at least one WWAN adapter detachably connected to the mobile server and electrically connected to the central network processor for transmitting and receiving data of a third data type; a data link layer circuit comprising: a central network processor comprising: a flow controller for dealing with data flow; and a bridge for transforming data types; and at least one storage device electrically connected to the central network processor for storing data and programs.

According to the claimed invention, a method for internetworking a WPAN, a WLAN, and a WWAN with a mobile server is disclosed. The mobile server comprising a physical layer circuit, a data link layer circuit, and at least one storage device, the method comprising:utilizing the physical layer circuit to receive data from the WPAN, the WLAN, and the WWAN; transmitting the data from the physical layer circuit to the data link layer circuit; utilizing the data link layer circuit to transform types of the data; utilizing the storage device to store the data; transmitting the data from the data link layer circuit to the physical layer circuit; and utilizing the physical layer circuit to transmit the data to the WPAN, the WLAN, and the WWAN.

It is an advantage of the claimed invention that the mobile server can make use of a central network processor to transform the data packet directly in the data link layer for internetworking the WPAN, the WLAN, and the WWAN so that the WPAN, the WLAN, and the WWAN can be integrated by the mobile server under the claimed architecture instead of building or reframing a new network architecture.

It is an advantage of the claimed invention that the mobile server can make use of a storage device to store system program and multimedia data so that users can quickly and conveniently access multimedia data and related information via the storage device.

These and other objectives and advantages of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of the mobile server for internetworking the WWAN, the WWAN, and the WPAN according to the present invention.

FIG. 2 is a functional block diagram of the first embodiment of the mobile server according to the present invention.

FIG. 3 is a functional block diagram of the second embodiment of the mobile server according to the present invention.

FIG. 4 is a flowchart of a data-transmitting/transforming process according to the embodiment as shown in FIG. 3.

### DETAILED DESCRIPTION

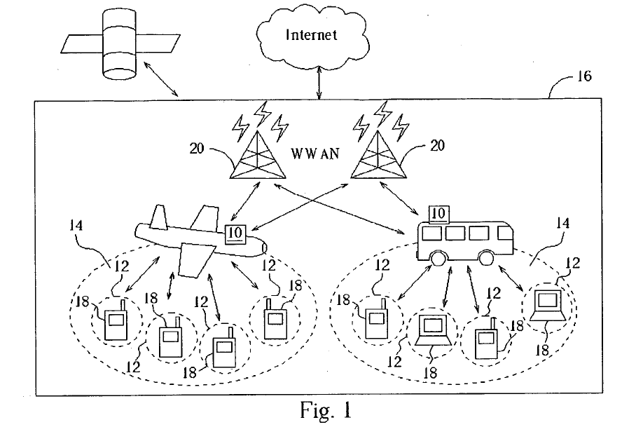

Please refer to FIG. 1, which is a schematic diagram of the mobile server 10 of the present invention for internetworking the WPAN 12, the WLAN 14, and the WWAN 16. As shown in FIG. 1, the mobile server 10 of the present invention installed within a mobile WLAN 14, such as a bus, an airplane, or a train, can play a role as an access point in the WLAN 14 for transmitting and receiving signals and data. Types of data transmitted in the WLAN 14 have to conform to an IEEE 802.11a/b/g specification. In the surroundings of the mobile WLAN 14, there are a plurality of mobile clients 18, namely the passengers of larges vehicles with portable communication equipment. Each mobile client 18 can build a corresponding WPAN 12 by installing a network interface device such as a Bluetooth adapter on his portable communication equipment. Therefore, the mobile clients 18 in the vehicle can make use of the WPANs 12 and the WLAN 14 to contact with each other. In addition, due to that the mobile server 10 installed in the vehicle stores some multimedia data or Internet resources, the mobile clients 18 in the vehicle can quickly browse desired information, such as music files or animations, via the mobile server 10 though the WPAN 12 and the WLAN 14 infrastructures. Please notice that the mobile server 10 installed in vehicle not only can be treated as the access point for the WPAN 12 and the WLAN 14, but also can connect the WLAN 14 and the WWAN 16. The WWAN 16 comprises a plurality of radio ports 20 for communicating with the mobile server 10. The radio ports 20 can also communicate with a radio port controller unit that is used to control the radio ports 20 and to establish contacts among the radio ports 20 in the WWAN 16. As shown in FIG. 1, data and signals can be transmitted in the WWAN 16 through a satellite system. Types of data transmitted in the WWAN 16 should conform to WWAN specifications, including GSM, GPRS, or 3G. Moreover, the radio port controller unit can be connected to another more widely arranged networks, such as the Internet or a telephone network. Therefore, the mobile clients 18 in the vehicle (the WLAN 14) installed with the mobile server 10 can communicate with WPAN 12, the WLAN 14, the WWAN 16, and even Internet via the mobile server 10 of the present invention.

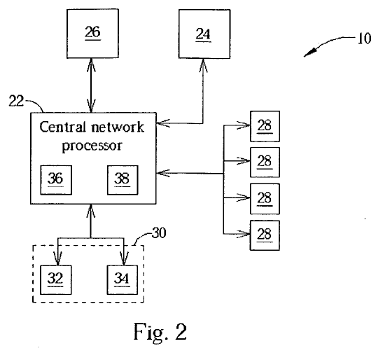

Please refer to FIG. 2, which is a functional block diagram of the mobile server 10 as shown in FIG. 1 according to the present invention. The mobile server 10 of the present embodiment comprises a central network processor 22, a WPAN adapter 24, a WLAN adapter 26, four WWAN adapters 28, and at least a storage device 30. Please notice that four WWAN adapters 28 are shown in the present embodiment due to that the transmission frequency related to the WWAN is lower and the data flows shall be balanced among the WWAN, the WLAN, and the WPAN. Actually, the amounts of the WPAN adapter 24, the WLAN adapter 26, and the WWAN adapters 28 should not be limited. The WPAN adapter 24 is detachably connected to the mobile server 10 and electrically connected to the central network processor 22 for transmitting, receiving, and processing data whose data type conforms to IEEE 802.15 or infrared specification. The WLAN adapter 26 is also detachably connected to the mobile server 10 and electrically connected to the central network processor 22 for transmitting, receiving, and processing data whose data type conforms to the IEEE 802.11a/b/g specification. Similarly, the WWAN adapter 28 is detachably connected to the mobile server 10 and electrically connected to the central network processor 22 for transmitting, receiving, and processing data whose data type conforms to GSM, GPRS, CDMA, W-CDMA, or 3G specifications. One critical characteristic of the mobile server 10 according to the present invention is that the storage device 30 is included. In the present embodiment, the storage device 30 comprises a hard disk 32 for storing multimedia data and a memory 34 for storing system programs. The memory 34 can be a DRAM, a SDRAM, or a read-only memory (ROM). The storage device 30 is electrically connected to the central network processor 22 so that the mobile clients 18 as shown in FIG. 1 can access data and information via the hard disk 32 of the storage device 30.

Please continue referring to FIG. 2. In the mobile server 10 of the present invention, the central network processor 22 plays a critical role. The central network processor 22 comprises a flow controller 36 for dealing with data flow and a bridge 38 for transforming data types. The flow controller 36 also can detect direction of the data flow, and the bridge 38 is a packet transforming circuit for transforming data among three data types (IEEE 802.15/infrared specification, IEEE 802.11a/b/g specification, and GSM, GPRS, CDMA, W-CDMA, or 3G). The bridge 38 can transform the data into the corresponding data type according the detected direction of the data flow. That is, if the direction of the data flow is from the WLAN to the WWAN, the flow controller 36 will command the bridge 38 to transform the data from the WLAN into the specific data type that has to conform to the GSM, GPRS, CDMA, W-CDMA, or 3G specification. After that, the data of newly transformed data type will be transmitted to the WWAN. Similarly, if the direction of the data flow is from the WWAN to the WPAN, the flow controller 36 will command the bridge 38 to transform the original data type that conforms to the GSM, GPRS, CDMA, W-CDMA, or 3G specification into another data type that conforms to the IEEE 802.1 5 or infrared specification. Certainly, if the flow controller 36 detects the data flow is from the WLAN to the WLAN, the data-type transforming process can be skipped so that the mobile server 10 of the present invention can be purely viewed as an access point in the WLAN.

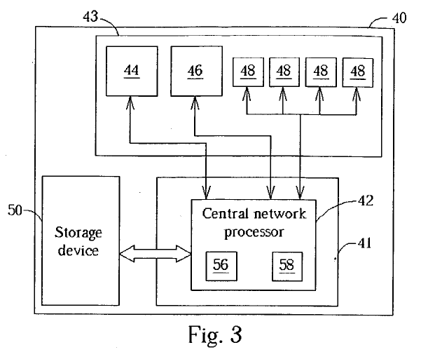

For clarifying the relation between the mobile server of the present invention and the existed network layer, another embodiment of the present invention is disclosed in FIG. 3, which is a functional block diagram of another embodiment of the mobile server 40. The present embodiment emphasizes that the transforming process of data types of the present invention proceeds in the data link layer of OSI architecture. The mobile server 40 comprises a physical layer circuit 43, a data link layer circuit 41, and a storage device 50. The data link layer circuit 41 comprises a central network processor 42, and the physical layer circuit 43 comprises a WPAN adapter 44, a WLAN adapter 46, and four WWAN adapters 48. As with the above-mentioned embodiment shown in FIG. 2, the amounts of the WPAN adapter 44, the WLAN adapter 46, and the WWAN adapters 48 can be varied according to the practical circumstances. The WPAN adapter 24 is detachably connected to the mobile server 10 and electrically connected to the central network processor 22 for transmitting, receiving, and processing data whose data type conforms to IEEE 802.15 or infrared specification. The WLAN adapter 26 is also detachably connected to the mobile server 10 and electrically connected to the central network processor 22 for transmitting, receiving, and processing data whose data type conforms to the IEEE 802.11a/b/g specification. Similarly, the WWAN adapter 28 is detachably connected to the mobile server 10 and electrically connected to the central network processor 22 for transmitting, receiving, and processing data whose data type conforms to GSM, GPRS, CDMA, W-CDMA, or 3G specification. Please notice that the data transmitted in the physical layer circuit 43 should conform to the physical layer specification of the OSI infrastructure. Similarly, the data transmitted in the data link layer circuit 41 should conform to the data link layer specification of the OSI infrastructure.

Please continue referring to FIG. 3, the data link layer circuit comprises a central network processor 42 whose functions are the same as the central network processor 22 as shown in FIG. 2. The central network processor 42 comprises a flow controller 56 for dealing with data flow and for detecting direction of the data flow, and a bridge 58 for transforming data types. In the mobile server 40, the transforming process of data types proceeds in the data link layer of OSI infrastructure. In addition, the mobile server 40 comprises storage device 50 electrically connected to the central network processor 42 for storing multimedia data and system programs.

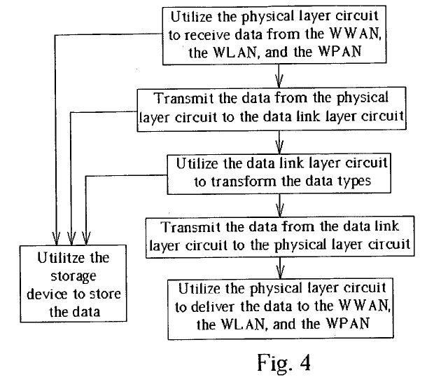

FIG. 4 is a flowchart describing related operations in the embodiment as shown in FIG. 3. Please refer to both FIG. 3 and FIG. 4. The physical layer circuit 43 receives data from the WPAN, the WLAN, and/or the WWAN. After that, the received data will be transmitted from the physical layer circuit 43 to the data link layer circuit 41. After the data arrives at the data link layer circuit 41, the flow controller 56 of the central network processor 42 will deal with the data flow and detect direction of the data flow, and the bridge 58 can perform data-type transformation in the data link layer. The transformed data is transmitted from the data link layer circuit 41 to the physical layer circuit 43. After that, the physical layer circuit 43 is utilized to deliver the data to the WPAN, the WLAN, and/or the WWAN. During the data transmitting process and the data-type transforming process, the user can make use of the central network processor 42 to store the data into storage device 50 and to access desired information from the storage device 50.

In contrast to the prior art, the mobile server of the present invention can operate data-type transforming processes with a data link layer circuit for internetworking a WPAN, a WWAN, and a WLAN. In addition, a storage device is provided to store system programs and multimedia data for allowing users to quickly access multimedia information. With the mobile server of the present invention, the WPAN, the WLAN, and the WWAN can be integrated by the mobile server under the claimed architecture instead of building or reframing a new network architecture.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A mobile server used as an access point in a wireless communication system for internetworking a WPAN, a WLAN, and a WWAN, the mobile server comprising:
a central network processor comprising:
a flow controller for dealing with data flow; and
a bridge for transforming data types;
at least one WPAN adapter detachably connected to the mobile server and electrically connected to the central network processor for transmitting, receiving, and processing data of a first data type;
at least one WLAN adapter detachably connected to the mobile server and electrically connected to the central network processor for transmitting, receiving, and processing data of a second data type;
at least one WWAN adapter detachably connected to the mobile server and electrically connected to the central network processor for transmitting, receiving, and processing data of a third data type; and
at least one storage device electrically connected to the central network processor for storing data and programs.

2. The mobile server of claim 1 wherein the flow controller can detect direction of the data flow, and the bridge can transform the data into the corresponding data type according the detected direction of the data flow.

3. The mobile server of claim 1 wherein the bridge is a packet transforming circuit for transforming the data into the first data type, the second data type, or the third data type.

4. The mobile server of claim 1 wherein the storage device is a hard disk, a DRAM, a SDRAM, or a ROM for storing system programs and multimedia data.

5. The mobile server of claim 1 wherein the first data type conforms to an IEEE 802.15 or an infrared-transmission specification.

6. The mobile server of claim 1 wherein the second data type conforms to an IEEE 802.11a/b/g specification.

7. The mobile server of claim 1 wherein the third data type conforms to a GSM, a GPRS, a CDMA, a W-CDMA, or a 3G specification.

8. A mobile server used as an access point in a wireless communication system for internetworking a WPAN, a WLAN, and a WWAN, the mobile server comprising:
a physical layer circuit comprising:
at least one WPAN adapter detachably connected to the mobile server and electrically connected to the central network processor for transmitting and receiving data of a first data type;
at least one WLAN adapter detachably connected to the mobile server and electrically connected to the central network processor for transmitting and receiving data of a second data type; and
at least one WWAN adapter detachably connected to the mobile server and electrically connected to the central network processor for transmitting and receiving data of a third data type;
a data link layer circuit comprising:
a central network processor comprising:
a flow controller for dealing with data flow; and
a bridge for transforming data types; and
at least one storage device electrically connected to the central network processor for storing data and programs.

9. The mobile server of claim 8 wherein the data transmitted in the physical layer circuit should conform to an open system interconnection (OSI) specification.

10. The mobile server of claim 8 wherein the data transmitted in the data link layer circuit should conform to an open system interconnection (OSI) specification.

11. The mobile server of claim 8 wherein the flow controller can detect direction of the data flow, and the bridge can transform the data into the corresponding data type according the detected direction of the data flow.

12. The mobile server of claim 8 wherein the bridge is a packet transforming circuit for transforming the data into the first data type, the second data type, or the third data type.

13. The mobile server of claim 8 wherein the storage device is a hard disk, a DRAM, a SDRAM, or a ROM for storing system programs and multimedia data.

14. The mobile server of claim 8 wherein the first data type conforms to an IEEE 802.15 or an infrared-transmission specification.

15. The mobile server of claim 8 wherein the second data type conforms to an IEEE 802.11a/b/g specification.

16. The mobile server of claim 8 wherein the third data type conforms to a GSM, a GPRS, a CDMA, a W-CDMA, or a 3G specification.

17. A method for internetworking a WPAN, a WLAN, and a WWAN with a mobile server, the mobile server comprising a physical layer circuit, a data link layer circuit, and at least one storage device, the method comprising:
utilizing the physical layer circuit to receive data from the WPAN, the WLAN, and the WWAN;
transmitting the data from the physical layer circuit to the data link layer circuit;
utilizing the data link layer circuit to transform types of the data;
utilizing the storage device to store the data;
transmitting the data from the data link layer circuit to the physical layer circuit; and
utilizing the physical layer circuit to transmit the data to the WPAN, the WLAN, and the WWAN.

18. The method of claim 17 wherein the physical layer circuit comprises at least one WPAN adapter, at least one WLAN adapter, and at least one WWAN adapter, wherein the WPAN adapter, the WLAN adapter, and the WWAN adapter are detachably connected to the mobile server.

19. The method of claim 17 wherein the data link layer circuit comprises a central network processor that includes a flow controller for dealing with data flow and a bridge for transforming data types, wherein the bridge is a packet transforming circuit.

20. The method of claim 17 wherein the storage device is a hard disk, a DRAM, a SDRAM, or a ROM for storing system programs and multimedia data.

21. The method of claim 17 wherein the data transmitted in the physical layer circuit should conform to an open system interconnection (OSI) specification.

22. The method of claim 17 wherein the data transmitted in the data link layer circuit should conform to an open system interconnection (OSI) specification.
